(19) United States
(12) Patent Application Publication
(10) Pub. No.: US 2017/0265074 A1
(43) Pub. Date: Sep. 14, 2017

(54) METHOD AND WEARABLE ELECTRONIC DEVICE

(71) Applicant: Lenovo (Beijing) Limited, Beijing (CN)

(72) Inventors: Pengyu Li, Beijing (CN); Yaqiang Wu, Beijing (CN); Yingwen Luo, Beijing (CN); Xiaomei Li, Beijing (CN); Hongxing Chen, Beijing (CN)

(21) Appl. No.: 15/455,642

(22) Filed: Mar. 10, 2017

(30) Foreign Application Priority Data
Mar. 10, 2016 (CN) 201610137945.7

(51) Int. Cl. H04W 12/06

(52) U.S. Cl. CPC H04W 12/06; H04B 1/385

(57) ABSTRACT

A method and an apparatus are disclosed. The method includes detecting a relationship between a device and a user, configuring the device to a first mode in response to detecting a first relationship between the device and the user, and configuring the device to a second mode in response to detecting a second relationship between the device and the user. The first apparatus variation includes a sensor that detects a relationship between a device and a user, and a controller that configures the device to a first mode in response to detecting a first relationship between the device and the user, and configures the device to a second mode in response to detecting a second relationship between the device and the user.

### FIELD

The present disclosure relates to a control technology, and in particular to a method and a wearable electronic device.

### BACKGROUND

With the development of smart devices, wearable electronic devices are used by an increasing number of users, and authentication and security grows increasingly more important. At present, there are generally two manners for authenticating a wearable electronic device. The first involves authenticating the wearable device once during a wearing process, and keeping the wearable device in an authenticated state without the user inputting authentication data multiple times. However, after removing the device, authentication is lost, and must be reestablished before use. The second manner requires the user to input authentication data each time a screen of a wearable electronic device is “timed out” during a wearing process.

### SUMMARY

Embodiments of a method and an apparatus are disclosed.

The method comprises detecting a relative position relationship between a wearable electronic device and a first part of a user; configuring the wearable electronic device to a first mode in response to detecting that the wearable electronic device and the first part of the user are in a first relative position relationship; and configuring the wearable electronic device to a second mode in response to detecting that the first relative position relationship of the wearable electronic device and the first part of the user has changed to a second relative position relationship.

The apparatus comprises a sensor that detects a relative position relationship between a wearable electronic device and a first part of a user; and a controller that configures the wearable electronic device to a first mode in response to the sensor detecting that the wearable electronic device and the first part of the user are in a first relative position relationship, and configures the wearable electronic device to a second mode in response to the sensor detecting the first relative position relationship of the wearable electronic device and the first part of the user has changed to a second relative position relationship.

### BRIEF DESCRIPTION OF THE DRAWINGS

The foregoing and other objects, features and advantages of the present disclosure will become more apparent from the detailed descriptions of the embodiments of the present disclosure in conjunction with the drawings. The drawings are used to provide a further understanding of the embodiments of the present disclosure and constitute a part of the Description, which, together with the embodiments of the present disclosure, serve to explain the present disclosure and are not construed as a limitation to the present disclosure. Unless explicitly indicated, the drawings should not be understood as being drawn to scale. In the drawings, the same reference numerals generally represent the same components or steps. In the drawings:

FIG. 1 is a schematic flow diagram of one embodiment of a control method;

FIG. 2 is a schematic flow diagram of one embodiment of a control method;

FIG. 3 is a schematic flow diagram of one embodiment of a control method;

FIG. 4 is a schematic flow diagram of one embodiment of a control method;

FIG. 5 is a schematic structural composition diagram of one embodiment of a wearable electronic device;

FIG. 6 is a schematic structural composition diagram of one embodiment of a wearable electronic device;

FIG. 7 is a schematic structural composition diagram of one embodiment of a wearable electronic device; and

FIG. 8 is a schematic structural composition diagram of one embodiment of a wearable electronic device.

### DETAILED DESCRIPTION

For a more detailed understanding of features and technical content of the embodiments, implementations of the embodiments are illustrated in detail along with the accompanying drawings. The drawings are merely for reference and description, rather than limiting the embodiments.

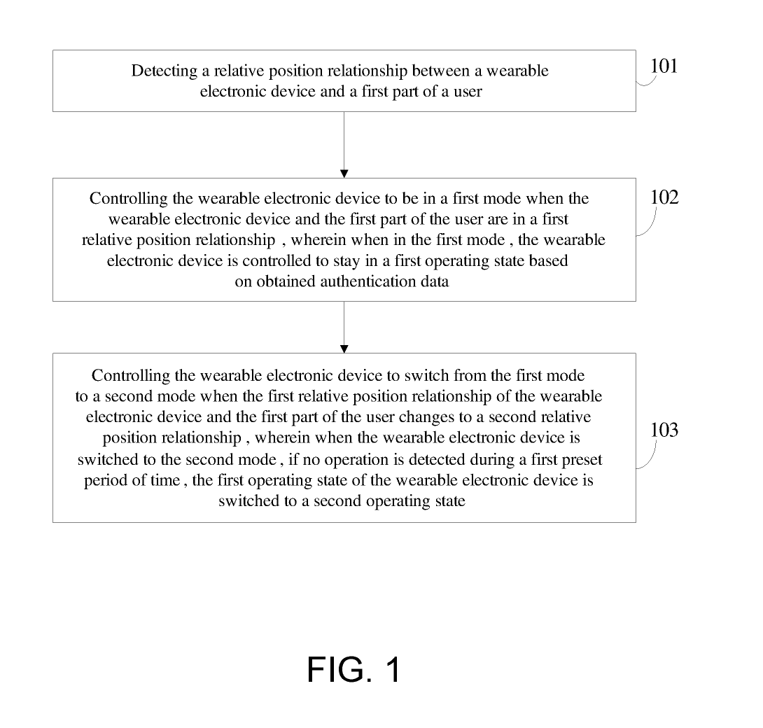

FIG. 1 is a schematic flow diagram of one embodiment of a control method. The control method in the embodiment is applied to a wearable electronic device, as shown in FIG. 1. In this embodiment, the control method comprises the following steps:

Step 101 involves detecting a relative position relationship between a wearable electronic device and a first part of a user.

In some embodiments, the wearable electronic device can be worn on the body of the user. The specific part of the user's body for wearing the device is determined according to a specific structure of the wearable electronic device. For example, if the wearable electronic device is a wrist-type device, then the wearable electronic device may be worn on a wrist of the user. One typical example of a wrist-type device is a smart watch. As another example, if the wearable electronic device is a helmet-type device or a glasses-type device, then the wearable electronic device may be worn on the head of the user. One typical example of a glasses-type device is a pair smart glasses.

In some embodiments, the wearable electronic device is provided with a sensor that can detect a relative position relationship between the wearable electronic device and a first part of the user. Herein, the first part is a part on the body of the user where the wearable electronic device is worn, for example, a wrist or the head, and the like. In some embodiments, the sensor may be a sensor capable of detecting a position and an attitude, such as a gyroscope, and the like.

In some embodiments, the relative position relationship between the wearable electronic device and the first part of the user is divided into two types: a first relative position relationship and a second relative position relationship. The first relative position relationship indicates that the wearable electronic device is worn on the body of the user, while the second relative position relationship indicates that the wearable electronic device is not worn on the body of the user.

Step 102 involves controlling the wearable electronic device to be in a first mode when the wearable electronic device and the first part of the user are in a first relative position relationship, wherein when in the first mode, the wearable electronic device is controlled to stay in a first operating state based on obtained authentication data.

In some embodiments, when the wearable electronic device and the first part of the user are in the first relative position relationship, the wearable electronic device is worn on the body of the user (in particular on the first part of the body of the user). At this time, the wearable electronic device is in the first mode. In the first mode, the user can, throughout the wearing process, maintain the wearable electronic device in the first operating mode state by inputting the authentication data to the wearable electronic device once. Herein, the first operating state is also referred to as an authenticated state, and when the wearable electronic device is in the authenticated state, the user may perform relevant operations on the wearable electronic device without inputting the authentication data.

In the first operating state, an operable authority level of the wearable electronic device is higher. For example, when the first operating state is an unlocked state, the user may use respective functions of the wearable electronic device in the unlocked state, such as receiving and sending a message, taking photos and the like.

In the above-mentioned solutions, the authentication data may be authentication data such as an input password, a gesture, a voice, a fingerprint, a vein, or other authentication data.

While the wearable electronic device is in the first mode and a screen is lit, if no operation is detected during a second preset period of time, the screen of the wearable electronic device is turned off. When the wearable electronic device is in the first mode and a screen is in an off mode, and an operation is detected, the screen of the wearable electronic device is turned on. Herein, when the user pushes a particular button on the wearable electronic device, the screen of the wearable electronic device is turned on, and when the wearable electronic device is lit, if no operation is detected within the second preset period of time, then the screen of the wearable electronic device is turned off, so as to save power. Since the wearable electronic device is in the first mode (regardless of whether the screen of the wearable electronic device is turned on or off), the wearable electronic device can stay in the first operating state (i.e., the authenticated state) throughout the wearing process after one authentication. In the authenticated state, even if the screen of the wearable electronic device is turned off, the user does not need to perform the authentication when the screen is turned on again.

Step 103 involves controlling the wearable electronic device to switch from the first mode to a second mode when the first relative position relationship of the wearable electronic device and the first part of the user changes to a second relative position relationship, wherein when the wearable electronic device is switched to the second mode, if no operation is detected during a first preset period of time, the first operating state of the wearable electronic device is switched to a second operating state.

In some embodiments, the operable authority level of the wearable electronic device in the second operating state is lower than that of the wearable electronic device in the first operating state.

In some embodiments, when the first relative position relationship between the wearable electronic device and the first part of the user is changed to the second relative position relationship, it is indicated that the wearable electronic device is removed from the body of the user. At this time, the wearable electronic device switches from the first mode to the second mode. The time at which the wearable electronic device switches from the first mode to the second mode is designated as T1, and if no operation is detected from time T1 to time T2, then the operating state of the wearable electronic device is switched from the first operating state to the second operating state. Herein, the second operating state is also referred to as the unauthenticated state, and when the wearable electronic device is in the unauthenticated state, the user can only perform relevant operations on the wearable electronic device after inputting the authentication data. The wearable electronic device has a lower operable authority level or has no operable authority in the second operating state. For example, when the second operating state is a locked state, the user cannot use functions of the wearable electronic device or can only use limited functions, such as turning on the screen.

In some embodiments, a duration between time T1 and time T2 is designated as the first preset period of time.

While the wearable electronic device is in the second mode and the screen is lit, if no operation is detected within a third preset period of time, the screen of the wearable electronic device is turned off, to save power. When the wearable electronic device is in the second mode and the screen is in an off mode and an operation is detected, the screen of the wearable electronic device is turned on. Herein, when the user pushes a particular button on the wearable electronic device, the screen of the wearable electronic device is turned on, and when the wearable electronic device is lit, if no operation is detected within the third preset period of time, then the screen of the wearable electronic device is turned off, to save power. Regardless of whether the screen of the wearable electronic device is turned on or off, since the wearable electronic device is in the second mode, the first operating state of the wearable electronic device is switched to the second operating state (i.e., the unauthenticated state) if no operation is detected within the first preset period of time. In the unauthenticated state, even if the screen of the wearable electronic device is turned on, the user needs to perform another authentication.

Through this technical solution, the security of user information in the wearable electronic device is ensured. Moreover, the user does not need to perform the authentication each time the screen is lit or the wearable electronic device is removed, simplifying user operation and improving user experience.

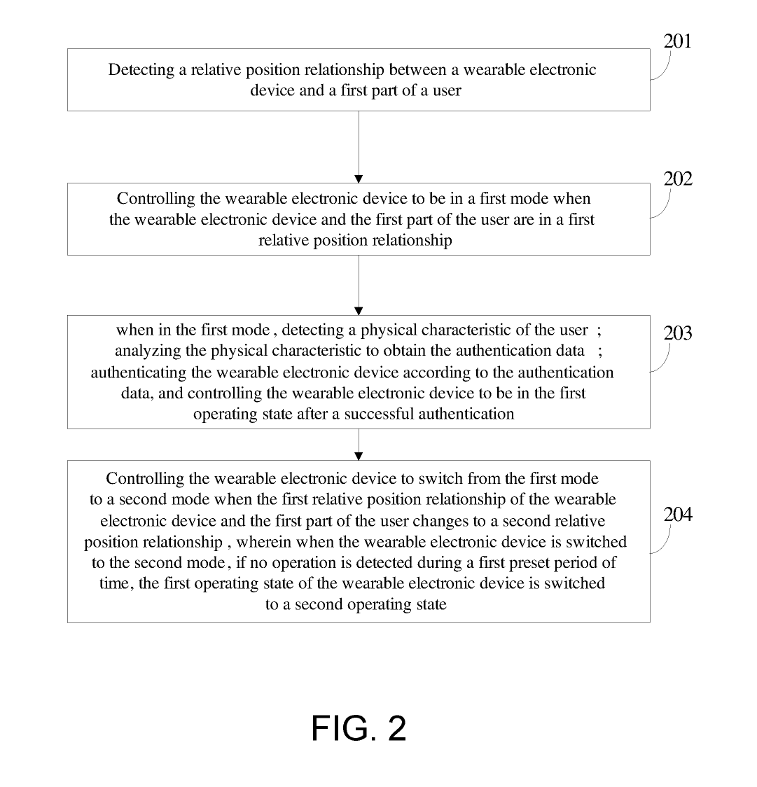

FIG. 2 is a schematic flow diagram of one embodiment of a control method. In some embodiments, the control method is applied to a wearable electronic device. As shown in FIG. 2, the control method comprises the following steps:

Step 201 involves detecting a relative position relationship between a wearable electronic device and a first part of a user.

In some embodiments, the wearable electronic device can be worn on the body of the user, and the specific part of the user body for wearing the device is determined according to a specific structure of the wearable electronic device. For example, if the wearable electronic device is a wrist-type device, then the wearable electronic device may be worn on a wrist of the user. A typical example of a wrist-type device is a smart watch. As another example, if the wearable electronic device is a helmet-type device or a glasses-type device, then the wearable electronic device may be worn on the head of the user. A typical example of a glasses-type device is a pair of smart glasses.

In some embodiments, the wearable electronic device is provided with a sensor used to detect a relative position relationship between a wearable electronic device and a first part of a user. Herein, the first part is a part on the body of the user where the wearable electronic device is worn, such as a wrist, a head, or another body par. In some embodiments, the sensor may be a sensor capable of detecting a position and an attitude, such as a gyroscope or other sensor with such a capability.

In some embodiments, the relative position relationship between the wearable electronic device and the first part of the user is divided into two types: a first relative position relationship and a second relative position relationship. The first relative position relationship indicates that the wearable electronic device is worn on the body of the user, while the second relative position relationship indicates that the wearable electronic device is not worn on the body of the user.

Step 202 involves controlling the wearable electronic device to be in a first mode when the wearable electronic device and the first part of the user are in a first relative position relationship.

In some embodiments, when the wearable electronic device and the first part of the user are in the first relative position relationship, it is indicated that the wearable electronic device is worn on the body of the user (in particular the first part of the body of the user). In such a state, the wearable electronic device is in the first mode. In the first mode, the user can, throughout the wearing process, maintain the wearable electronic device in the first operating state by inputting the authentication data to the wearable electronic device one time.

In this description, the first operating state will also be referred to as an authenticated state. When the wearable electronic device is in the authenticated state, the user may perform relevant operations on the wearable electronic device without inputting the authentication data. In the first operating state, an operable authority level of the wearable electronic device is higher. For example, in some embodiments, when the first operating state is an unlocked state, the user may use respective functions of the wearable electronic device in the unlocked state, such as receiving and sending a message, photographing and the like, that may not be possible in another state with a lower authority level.

Step 203 involves detecting a physical characteristic of the user while in the first mode; analyzing the physical characteristic to obtain the authentication data; authenticating the wearable electronic device according to the authentication data, and controlling the wearable electronic device to be in the first operating state after a successful authentication.

In some embodiments, the authentication is performed by a physical characteristic of the user, as the physical characteristic of the user is unique. In some embodiments, the physical characteristic may be a fingerprint, a choroid, or other physical characteristic. When the user wears the wearable electronic device, the wearable electronic device may acquire the physical characteristic of the user directly. Then, the physical characteristic is parsed to obtain the authentication data. In some embodiments, the authentication data may be the physical characteristic itself, and in some embodiments the authentication data may be password data corresponding one-to-one with the physical characteristic. Next, the wearable electronic device is authenticated according to the authentication data, and the wearable electronic device is controlled to be in the first operating state (the authenticated state) after a successful authentication.

When the wearable electronic device is in the first mode and a screen is in a lit mode, if no operation is detected during a second preset period of time, the screen of the wearable electronic device is turned off. When the wearable electronic device is in the first mode and a screen is in an off mode, and an operation is detected, the screen of the wearable electronic device is turned on. When the user pushes a particular button on the wearable electronic device, the screen of the wearable electronic device is turned on, and when the wearable electronic device is in the lit mode, if no operation is detected within the second preset period of time, then the screen of the wearable electronic device is turned off, to save power. Regardless of whether the screen of the wearable electronic device is turned on or off, since the wearable electronic device is in the first mode, the wearable electronic device can stay in the first operating state, i.e., the authenticated state, throughout the wearing process after one authentication. In the authenticated state, even if the screen of the wearable electronic device is turned off, the user does not need to perform the authentication when the screen is in the lit mode again.

Step 204 involves controlling the wearable electronic device to switch from the first mode to a second mode when the first relative position relationship of the wearable electronic device and the first part of the user changes to a second relative position relationship; wherein, when the wearable electronic device is switched to the second mode, if no operation is detected during a first preset period of time, the first operating state of the wearable electronic device is switched to a second operating state.

The operable authority level of the wearable electronic device in the second operating state is lower than that of the wearable electronic device in the first operating state.

In some embodiments, when the first relative position relationship between the wearable electronic device and the first part of the user is changed to the second relative position relationship, it indicates that the wearable electronic device is removed from the body of the user. At this time, the wearable electronic device switches from the first mode to the second mode. The time at which the wearable electronic device switches from the first mode to the second mode is designated as T1, and if no operation is detected from time T1 to a time T2, then the operating state of the wearable electronic device is in is switched to the second operating state. In this description, the second operating state is also referred to as the unauthenticated state, and when the wearable electronic device is in the unauthenticated state, the user can only perform relevant operations on the wearable electronic device after inputting the authentication data. The wearable electronic device has a lower operable authority level or has no operable authority in the second operating state. For example, when the second operating state comprises a locked state, the user cannot use any functions of the wearable electronic device or can only use limited functions, such as turning on the screen.

In the above-mentioned solution, a duration between time T1 and time T2 is designated as the first preset period of time.

When the wearable electronic device is in the second mode and the screen is in the lit mode, if no operation is detected within a third preset period of time, the screen of the wearable electronic device is turned off, to save power. When the wearable electronic device is in the second mode and the screen is in an off mode, and an operation is detected, the screen of the wearable electronic device is turned on. Herein, when the user pushes a particular button on the wearable electronic device, the screen of the wearable electronic device is turned on, and when the wearable electronic device is in the lit mode, if no operation is detected within the third preset period of time, then the screen of the wearable electronic device is turned off, to save power. Since the wearable electronic device is in the second mode, regardless of whether the screen of the wearable electronic device is turned on or off, the first operating state of the wearable electronic device is switched to the second operating state (the unauthenticated state) if no operation is detected within the first preset period of time. In the unauthenticated state, even if the screen of the wearable electronic device is turned on, the user needs to perform another authentication.

In this manner, security of user information in the wearable electronic device is ensured, while at the same time, the user does not need to perform the authentication each time the screen is in a lit mode or the wearable electronic device is removed, simplifying a user operation and improving user experience.

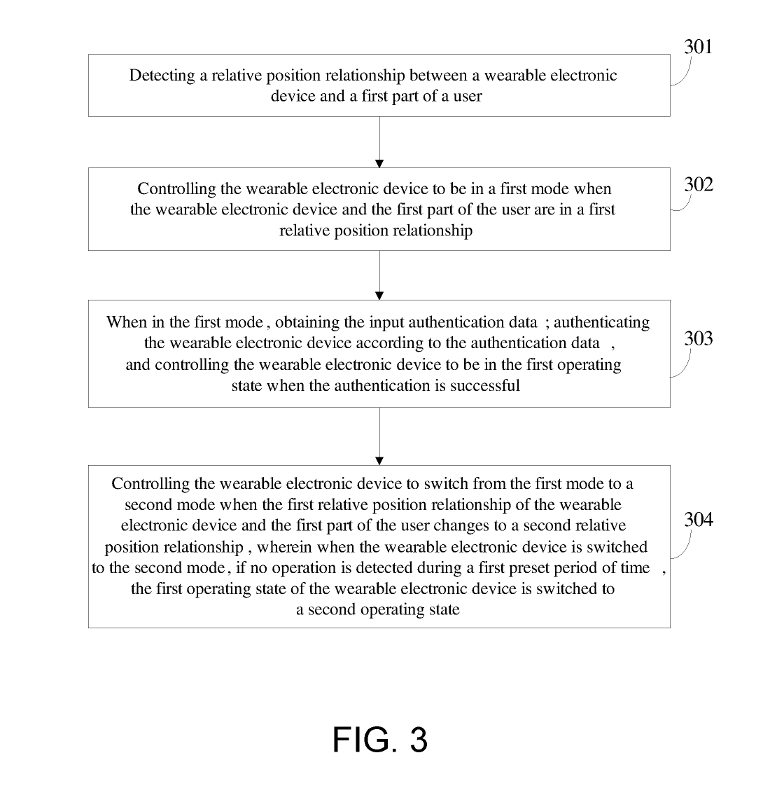

FIG. 3 is a schematic flow diagram of one embodiment of a control method. The control method in the embodiment is applied to a wearable electronic device. As shown in FIG. 3, the control method comprises the following steps:

Step 301 involves detecting a relative position relationship between a wearable electronic device and a first part of a user.

In some embodiments, the wearable electronic device can be worn on the body of the user, and the specific part of the user body for wearing the device is determined according to a specific structure of the wearable electronic device. For example, if the wearable electronic device is a wrist-type device, then the wearable electronic device may be worn on a wrist of the user. A typical wrist-type device may be a smart watch. If the wearable electronic device is a helmet-type device or a glasses-type device, then the wearable electronic device may be worn on the head of the user. A typical example of a glasses-type device is a pair of smart glasses.

In some embodiments, the wearable electronic device is provided with a sensor, used to detect a relative position relationship between a wearable electronic device and a first part of a user. Herein, the first part is a part on the body of the user where the wearable electronic device is worn, such as a wrist, the head, or other suitable body part. The sensor may be a sensor capable of detecting a position and an attitude, such as a gyroscope, or other capable sensor.

In some embodiments, the relative position relationship between the wearable electronic device and the first part of the user is divided into two types: a first relative position relationship and a second relative position relationship. The first relative position relationship indicates that the wearable electronic device is worn on the body of the user, while the second relative position relationship indicates that the wearable electronic device is not worn on the body of the user.

Step 302 involves controlling the wearable electronic device to be in a first mode when the wearable electronic device and the first part of the user are in a first relative position relationship.

In some embodiments, when the wearable electronic device and the first part of the user are in the first relative position relationship, it indicates that the wearable electronic device is worn on the body of the user, in particular the first part of the body of the user. At this time, the wearable electronic device is in the first mode. In the first mode, the user can, throughout the wearing process, maintain the wearable electronic device in the first operating state by inputting the authentication data to the wearable electronic device once. In this description, the first operating state is also referred to as an authenticated state, and when the wearable electronic device is in the authenticated state, the user may perform relevant operations on the wearable electronic device without inputting the authentication data. In the first operating state, an operable authority level of the wearable electronic device is higher. For example, when the first operating state is an unlocked state, the user may use respective functions of the wearable electronic device in the unlocked state, such as receiving and sending a message, taking a photo, or other common functions of a wearable electronic device.

Step 303 involves (when in the first mode) obtaining the input authentication data; authenticating the wearable electronic device according to the authentication data, and controlling the wearable electronic device to be in the first operating state when the authentication is successful.

In some embodiments, the authentication is performed by the authentication data input by the user, which be a password, a gesture, or other authentication data. In some embodiments, the electronic device is authenticated according to the authentication data, and the wearable electronic device is controlled to be in the first operating state (the authenticated state) after a successful authentication.

When the wearable electronic device is in the first mode and a screen is in a lit mode, if no operation is detected during a second preset period of time, the screen of the wearable electronic device is turned off. When the wearable electronic device is in the first mode and a screen is in an off mode, and an operation is detected, the screen of the wearable electronic device is turned off. Herein, when the user pushes a particular button on the wearable electronic device, the screen of the wearable electronic device is turned on, and when the wearable electronic device is in the lit mode, if no operation is detected within the second preset period of time, then the screen of the wearable electronic device is turned off, to save power. Regardless of whether the screen of the wearable electronic device is turned on or off, since the wearable electronic device is in the first mode, the wearable electronic device can stay in the first operating state (the authenticated state) throughout the wearing process after one authentication. In the authenticated state, even if the screen of the wearable electronic device is turned off, the user does not need to perform the authentication when the screen is in the lit mode again.

Step 304 involves controlling the wearable electronic device to switch from the first mode to a second mode when the first relative position relationship of the wearable electronic device and the first part of the user changes to a second relative position relationship, wherein when the wearable electronic device is switched to the second mode, if no operation is detected during a first preset period of time, the first operating state of the wearable electronic device is switched to a second operating state.

The operable authority level of the wearable electronic device in the second operating state is lower than that of the wearable electronic device in the first operating state.

In some embodiments, when the first relative position relationship between the wearable electronic device and the first part of the user is changed to the second relative position relationship, it is indicated that the wearable electronic device is removed from the body of the user. At this time, the wearable electronic device switches from the first mode to the second mode. The time at which the wearable electronic device switches from the first mode to the second mode is designated as T1, and if no operation is detected from time T1 to a time T2, then the operating state of the wearable electronic device is switched to the second operating state. The second operating state is also referred to as the unauthenticated state, and when the wearable electronic device is in the unauthenticated state, the user can only perform relevant operations on the wearable electronic device after inputting the authentication data. The wearable electronic device has a lower operable authority level or has no operable authority in the second operating state. For example, when the second operating state is a locked state, the user cannot use functions of the wearable electronic device or can only use limited functions, such as turning on the screen, in the locked state.

In the above-mentioned solution, a duration between time T1 and time T2 is designated as a first preset period of time.

When the wearable electronic device is in the second mode and the screen is in the lit mode, if no operation is detected within a third preset period of time, the screen of the wearable electronic device is turned off, to save power. When the wearable electronic device is in the second mode and the screen is in an off mode, and an operation is detected, the screen of the wearable electronic device is turned on. When the user pushes a particular button on the wearable electronic device, the screen of the wearable electronic device is turned on, and, when the wearable electronic device is in the lit mode, if no operation is detected within the third preset period of time, then the screen of the wearable electronic device is turned off, to save power. Regardless of whether the screen of the wearable electronic device is turned on or off, since the wearable electronic device is in the second mode, the first operating state of the wearable electronic device is switched to the second operating state (the unauthenticated state) if no operation is detected within the first preset period of time. In the unauthenticated state, if the screen of the wearable electronic device is turned on, the user needs to perform another authentication.

In this manner, security of user information in the wearable electronic device is ensured. Moreover, the user does not need to perform the authentication each time the screen is in a lit mode or the wearable electronic device is removed, simplifying a user operation and improving user experience.

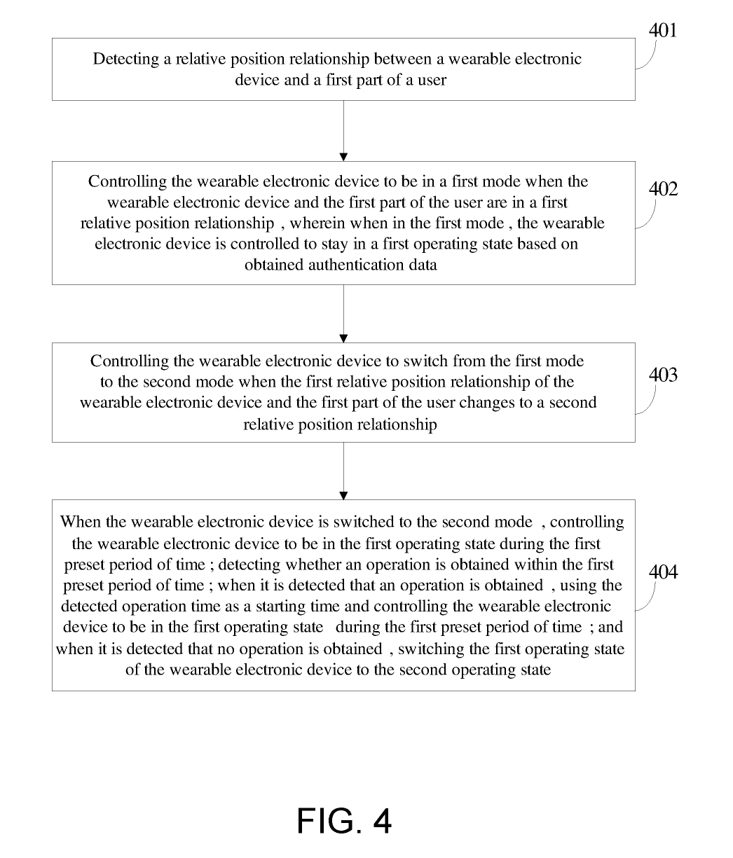

FIG. 4 is a schematic flow diagram of one embodiment of a control method. The control method in the embodiment is applied to a wearable electronic device. As shown in FIG. 4, the control method comprises the following steps:

Step 401 involves detecting a relative position relationship between a wearable electronic device and a first part of a user.

In some embodiments, the wearable electronic device can be worn on the body of the user, and the specific part of the user body for wearing the device is determined according to a specific structure of the wearable electronic device. For example, if the wearable electronic device is a wrist-type device, then the wearable electronic device may be worn on a wrist of the user. A typical example of a wrist-type device is a smart watch. As another example, if the wearable electronic device is a helmet-type device or a glasses-type device, then the wearable electronic device may be worn on the head of the user. A typical example of a glasses-type device is smart glasses.

In some embodiments, the wearable electronic device is provided with a sensor, used to detect a relative position relationship between a wearable electronic device and a first part of a user. In some embodiments, the first part is a part on the body of the user where the wearable electronic device is worn, such as a wrist or the head, and the like. In some embodiments, the sensor may be a sensor capable of detecting a position and an attitude, such as a gyroscope, and the like.

In some embodiments, the relative position relationship between the wearable electronic device and the first part of the user is divided into two types: a first relative position relationship and a second relative position relationship. The first relative position relationship indicates that the wearable electronic device is worn on the body of the user, while the second relative position relationship indicates that the wearable electronic device is not worn on the body of the user.

Step 402 involves controlling the wearable electronic device to be in a first mode when the wearable electronic device and the first part of the user are in a first relative position relationship. While in the first mode, the wearable electronic device is controlled to stay in a first operating state based on obtained authentication data.

In some embodiments, when the wearable electronic device and the first part of the user are in the first relative position relationship, it indicates that the wearable electronic device is worn on the body of the user (in particular the first part of the body of the user). In such a state, the wearable electronic device is in the first mode. In the first mode, the user can, throughout the wearing process, maintain the wearable electronic device in the first operating state by inputting the authentication data to the wearable electronic device once. Herein, the first operating state is also referred to as an authenticated state, and when the wearable electronic device is in the authenticated state, the user may perform relevant operations on the wearable electronic device without inputting the authentication data. In the first operating state, an operable authority level of the wearable electronic device is higher. For example, when the first operating state is an unlocked state, the user may use respective functions of the wearable electronic device in the unlocked state, such as receiving and sending a message, photographing and the like.

In the above-mentioned solutions, the authentication data may be authentication data such as an input password, a gesture, a voice, a fingerprint, a vein, or other type of authentication data.

When the wearable electronic device is in the first mode and a screen is in a lit mode, if no operation is detected during a second preset period of time, the screen of the wearable electronic device is turned off. When the wearable electronic device is in the first mode and a screen is in an off mode, and an operation is detected, the screen of the wearable electronic device is turned on. Herein, when the user pushes a particular button on the wearable electronic device, the screen of the wearable electronic device is turned on, and when the wearable electronic device is in the lit mode, if no operation is detected within the second preset period of time, then the screen of the wearable electronic device is turned off, to save power. Regardless of whether the screen of the wearable electronic device is turned on or off, since the wearable electronic device is in the first mode, the wearable electronic device can stay in the first operating state, (the authenticated state), throughout the wearing process after one authentication. In the authenticated state, even if the screen of the wearable electronic device is turned off, the user does not need to perform the authentication when the screen is in the lit mode again.

Step 403 involves controlling the wearable electronic device to switch from the first mode to the second mode when the first relative position relationship of the wearable electronic device and the first part of the user changes to a second relative position relationship.

Step 404 involves controlling the wearable electronic device to be in the first operating state during the first preset period of time when the wearable electronic device is switched to the second mode; detecting whether an operation is obtained within the first preset period of time; when it is detected that an operation is obtained, using the detected operation time as a starting time and controlling the wearable electronic device to be in the first operating state during the first preset period of time; and when it is detected that no operation is obtained, switching the first operating state of the wearable electronic device to the second operating state.

The operable authority level of the wearable electronic device in the second operating state is lower than that of the wearable electronic device in the first operating state.

In some embodiments, when the relative position relationship between the wearable electronic device and the first part of the user is changed to the second relative position relationship, it indicates that the wearable electronic device is removed from the body of the user. At this time, the wearable electronic device switches from the first mode to the second mode. The time at which the wearable electronic device switches from the first mode to the second mode is T1. If no operation is detected from time T1 to a time T2, then the operating state of the wearable electronic device is switched to the second operating state. Herein, the second operating state is also referred to as the unauthenticated state, and when the wearable electronic device is in the unauthenticated state, the user can only perform relevant operations on the wearable electronic device after inputting the authentication data. The wearable electronic device has a lower operable authority level or has no operable authority in the second operating state. For example, when the second operating state is a locked state, the user cannot use functions of the wearable electronic device or can only use limited functions, such as turning on the screen.

Moreover, at a time T3 between time T1 and time T2, if an operation is detected, then the time at which the operation is detected is taken as a start time, and during a preset period of time after time T3 (i.e., between time T3 and a time T4), the wearable electronic device is controlled to be in the first operating state, and a detection is continuously performed between time T3 and time T4 to determine whether an operation is made. In this manner, the wearable electronic device always stays in the first operating state for the first preset period of time after the last operation of the user. In the above-described solution, a duration between time T1 and time T2 is the first preset period of time, and a duration between time T3 and time T4 is the second preset period of time.

When the wearable electronic device is in the second mode and the screen is in the lit mode, if no operation is detected within a third preset period of time, the screen of the wearable electronic device is turned off, to save power. After the wearable electronic device is in the second mode and the screen is in an off mode, and an operation is detected, the screen of the wearable electronic device is turned on. After the user pushes a particular button on the wearable electronic device, the screen of the wearable electronic device is turned on. When the wearable electronic device is in the lit mode, if no operation is detected within the third preset period of time, then the screen of the wearable electronic device is turned off, to save power. Regardless of whether the screen of the wearable electronic device is turned on or off, since the wearable electronic device is in the second mode, the first operating state of the wearable electronic device is switched to the second operating state (the unauthenticated state) if no operation is detected within the first preset period of time. In the unauthenticated state, even if the screen of the wearable electronic device is turned on, the user needs to perform another authentication.

In some embodiments, when the wearable electronic device is in the second mode, the input authentication data is obtained, the wearable electronic device is authenticated according to the authentication data, and the wearable electronic device is controlled to switch from the second operating state to the first operating state after a successful authentication.

In the embodiments, security of user information in the wearable electronic device is ensured. Moreover, the user does not need to perform the authentication each time the screen is in a lit mode or the wearable electronic device is removed, simplifying a user operation and improving user experience.

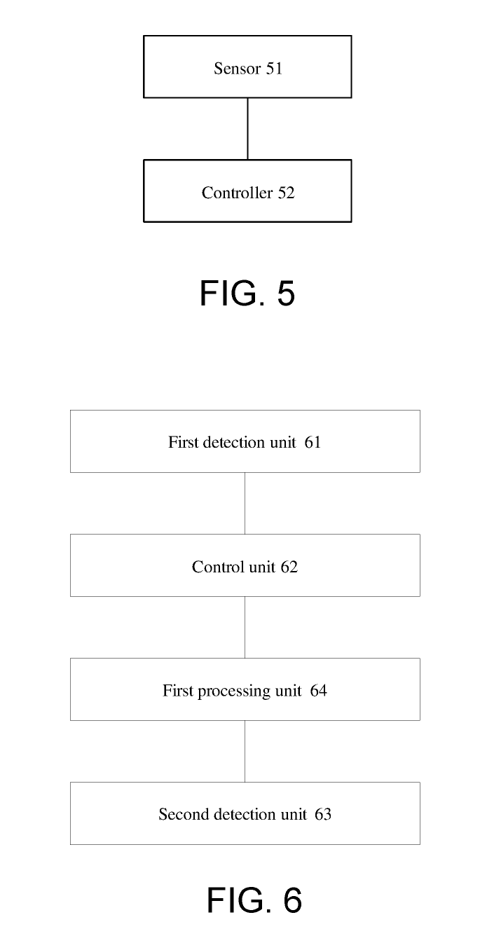

FIG. 5 is a structural composition diagram of one embodiment of a wearable electronic device. As shown in FIG. 5, the wearable electronic device comprises a sensor 51, and a controller 52.

The sensor 51 is used to detect a relative position relationship between a wearable electronic device and a first part of a user.

The controller 52 is used to control the wearable electronic device to be in a first mode when the wearable electronic device and the first part of the user are in a first relative position relationship, wherein when in the first mode, the wearable electronic device is controlled to stay in a first operating state based on obtained authentication data. The controller 52 also controls the wearable electronic device to switch from the first mode to a second mode when the first relative position relationship of the wearable electronic device and the first part of the user changes to a second relative position relationship. When the wearable electronic device is switched to the second mode, if no operation is detected during a first preset period of time, the controller 52 switches the first operating state of the wearable electronic device to a second operating state.

The operable authority level of the wearable electronic device in the second operating state is lower than that of the wearable electronic device in the first operating state.

Those skilled in the art should appreciate that functions implemented by each unit in the wearable electronic device shown in FIG. 5 can be understood with reference to relevant descriptions of the above-mentioned control method.

FIG. 6 is a structural composition diagram of one embodiment of a wearable electronic device. As shown in FIG. 6, the wearable electronic device comprises a first detection unit 61, a control unit 62, a second detection unit 63, and a first processing unit 64.

The first detection unit 61 is used to detect a relative position relationship between a wearable electronic device and a first part of a user.

The control unit 62 is used to control the wearable electronic device to be in a first mode when the wearable electronic device and the first part of the user are in a first relative position relationship. When in the first mode, the wearable electronic device is controlled to stay in a first operating state based on obtained authentication data. The control unit 62 also controls the wearable electronic device to switch from the first mode to a second mode when the first relative position relationship of the wearable electronic device and the first part of the user changes to a second relative position relationship. When the wearable electronic device is switched to the second mode, if no operation is detected during a first preset period of time, the control unit 62 switches the first operating state of the wearable electronic device to a second operating state.

The operable authority level of the wearable electronic device in the second operating state is lower than that of the wearable electronic device in the first operating state.

The second detection unit 63 is used to detect a physical characteristic of the user.

The first processing unit 64 is used to analyze the physical characteristic to obtain the authentication data and to authenticate the wearable electronic device according to the authentication data.

The control unit 62 is further used to put the wearable electronic device in the first operating state after a successful authentication.

Those skilled in the art should appreciate that functions implemented by each unit in the wearable electronic device shown in FIG. 6 can be understood with reference to relevant descriptions of the above-mentioned control method. Functions of each unit in the wearable electronic device shown in FIG. 6 may be implemented by a program running on a processor, or by specific logic circuits.

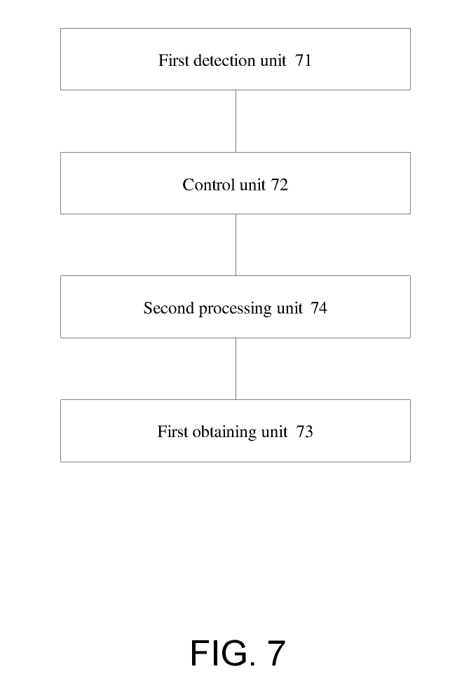

FIG. 7 is a structural composition diagram of one embodiment of a wearable electronic device. As shown in FIG. 7, the wearable electronic device comprises a first detection unit 71, a control unit 72, a first obtaining unit 73, and a second processing unit 74.

The first detection unit 71 is used to detect a relative position relationship between a wearable electronic device and a first part of a user;

The control unit 72 is used to control the wearable electronic device to be in a first mode when the wearable electronic device and the first part of the user are in a first relative position relationship. When in the first mode, the wearable electronic device is controlled to stay in a first operating state based on obtained authentication data. The control unit 72 also controls the wearable electronic device to switch from the first mode to a second mode when the first relative position relationship of the wearable electronic device and the first part of the user changes to a second relative position relationship. When the wearable electronic device is switched to the second mode, if no operation is detected during a first preset period of time, the control unit 72 switches the first operating state of the wearable electronic device to a second operating state.

The operable authority level of the wearable electronic device in the second operating state is lower than that of the wearable electronic device in the first operating state.

The first obtaining unit 73 is used to obtain the input authentication data;

The second processing unit 74 is used to authenticate the wearable electronic device according to the authentication data.

The control unit 72 is further used to control the wearable electronic device to be in the first operating state when the authentication is successful.

Those skilled in the art should appreciate that functions implemented by each unit in the wearable electronic device shown in FIG. 7 can be understood with reference to relevant descriptions of the above-mentioned control method. Functions of each unit in the wearable electronic device shown in FIG. 7 may be implemented by a program running on a processor, or by specific logic circuits.

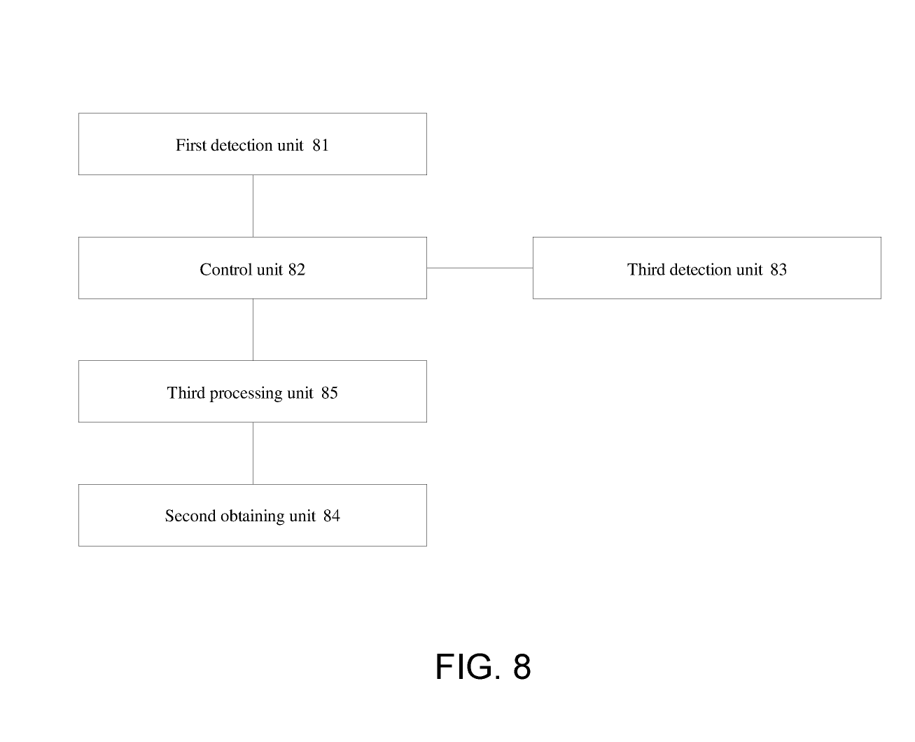

FIG. 8 is a structural composition diagram of one embodiment of a wearable electronic device. As shown in FIG. 8, the wearable electronic device comprises a first detection unit 81, a control unit 82, a third detection unit 83, a second obtaining unit 84 and a third processing unit 85.

The first detection unit 81 detects a relative position relationship between a wearable electronic device and a first part of a user.

The control unit 82 controls the wearable electronic device to be in a first mode when the wearable electronic device and the first part of the user are in a first relative position relationship. When in the first mode, the control unit 82 maintains the wearable electronic device in a first operating state based on obtained authentication data. The control unit 82 also controls the wearable electronic device to switch from the first mode to a second mode after the first relative position relationship of the wearable electronic device and the first part of the user changes to a second relative position relationship. After the wearable electronic device is switched to the second mode, if no operation is detected during a first preset period of time, the first operating state of the wearable electronic device is switched to a second operating state.

The operable authority level of the wearable electronic device in the second operating state is lower than that of the wearable electronic device in the first operating state.

The control unit 82 also controls the wearable electronic device to be in the first operating state during the first preset period of time when the wearable electronic device is switched to the second mode.

The third detection unit 83 is used to detect whether an operation is obtained during the first preset period of time.

After it is detected that an operation is obtained, the control unit 82 uses the detected operation time as a starting time and controls the wearable electronic device to be in the first operating state during the first preset period of time. After it is detected that no operation is obtained, the control unit 82 switches the operating state of the wearable electronic device from the first operating state of the wearable electronic device to the second operating state.

The second obtaining unit 84 obtains the input authentication data when the wearable electronic device is in the second operating state.

The third processing unit 85 authenticates the wearable electronic device according to the authentication data.

The control unit 82 controls the wearable electronic device to switch from the second operating state to the first operating state after a successful authentication.

The control unit 82 turns off the screen of the wearable electronic device if no operation is detected during a second preset period of time while the wearable electronic device is in the first mode and a screen is in a lit mode. When the wearable electronic device is in the first mode and the screen is turned off, if an operation is detected, the control unit 82 turns on the screen of the wearable electronic device. When the wearable electronic device is in the second mode and the screen is in a lit mode, if no operation is detected during a third preset period of time, the control unit 82 turns off the screen of the wearable electronic device. When the wearable electronic device is in the second mode and the screen is turned off, if an operation is detected, the control unit 82 turns on the screen of the wearable electronic device.

Those skilled in the art should appreciate that functions implemented by each unit in the wearable electronic device shown in FIG. 8 can be understood with reference to relevant descriptions of the above-mentioned control method. Functions of each unit in the wearable electronic device shown in FIG. 8 may be implemented by a program running on a processor, or by specific logic circuits.

The technical solutions recorded in the embodiments can be arbitrarily combined without conflicts.

In the several embodiments provided, it should be understood that the disclosed method and smart device may be realized in other manners. The above described device embodiments are merely illustrative. For example, the unit division is merely a logical function division and there may be other methods of division in actual implementation. For example, multiple units or components may be combined or integrated into another system, or some features can be ignored or not performed. Additionally, mutual couplings, direct couplings, or communication connections of various component parts as shown or discussed may be implemented through some interfaces, and indirect couplings or communication connections of devices or units may be in an electrical, mechanical, or other form.

The above units used as separate components may or may not be physically independent of each other. The element illustrated as a unit may or may not be a physical unit, that is be either located at a position or distributed over a plurality of network units. A part or all of the units may be selected according to the actual needs to achieve the objectives of the solutions of the embodiments.

In addition, the functional units in the various embodiments may be wholly integrated into one second processing unit, or may separately and physically exist as a single unit, or two or more units may be integrated into one unit. The above integrated units may be implemented in a form of hardware, or may also be implemented in a form of hardware plus a software functional unit.

The above embodiments are only some specific embodiments, and the protection scope of the present disclosure is not limited thereto. It will readily occur to those skilled in the art, within the technical scope of the disclosure, that changes or substitutions should be covered within the protected scope of the present disclosure.

What is claimed is:

1. A method, comprising
detecting a relative position relationship between a wearable electronic device and a first part of a user;
configuring the wearable electronic device to a first mode in response to detecting that the wearable electronic device and the first part of the user are in a first relative position relationship; and
configuring the wearable electronic device to a second mode in response to detecting that the first relative position relationship of the wearable electronic device and the first part of the user has changed to a second relative position relationship.

2. The method of claim 1, further comprising
maintaining the wearable electronic device in a first operating state based on obtained authentication data while the electronic device is in the first mode.

3. The method of claim 2, further comprising
configuring the wearable electronic device to a second operating state after the wearable electronic device is configured to the second mode if no operation is detected within a first preset period of time.

4. The method of claim 3, wherein
an operable authority level of the wearable electronic device in the second operating state is lower than that of the wearable electronic device in the first operating state.

5. The method of claim 4, wherein maintaining the wearable electronic device in the first operating state based on obtained authentication data while the electronic device is in the first mode comprises
detecting a physical characteristic of the user;
analyzing the physical characteristic to obtain the authentication data;
authenticating the wearable electronic device according to the authentication data; and
controlling the wearable electronic device to be in the first operating state after a successful authentication.

6. The method of claim 4, wherein maintaining the wearable electronic device in a first operating state based on obtained authentication data while the electronic device is in the first mode comprises
obtaining the input authentication data;
authenticating the wearable electronic device according to the authentication data; and
controlling the wearable electronic device to be in the first operating state after the authentication is successful.

7. The method of claim 4, wherein configuring the wearable electronic device to the second operating state after the wearable electronic device is configured to the second mode if no operation is detected within a first preset period of time comprises
maintaining the wearable electronic device in the first operating state for a first preset period of time after the wearable electronic device is switched to the second mode;
detecting whether an operation is made during the first preset period of time; and
if no operation is detected during the first preset period of time, configuring the wearable electronic device to the second operating state.

8. The method of claim 6 further comprising
obtaining the input authentication data while the wearable electronic device is in the second operating state;
authenticating the wearable electronic device according to the authentication data; and
configuring the wearable electronic device to the first operating state after successfully authenticating the wearable electronic device according to the authentication data.

9. The method of claim 1, further comprising
turning off a screen of the wearable electronic device after no operation is detected within a second preset period of time while the wearable electronic device is in the first mode and the screen is in a lit mode;
turning on the screen of the wearable electronic device after an operation is detected while the wearable electronic device is in the first mode and the screen is turned off.

10. An apparatus, comprising
a sensor that
detects a relative position relationship between a wearable electronic device and a first part of a user; and
a controller that
configures the wearable electronic device to a first mode in response to the sensor detecting that the wearable electronic device and the first part of the user are in a first relative position relationship, and
configures the wearable electronic device to a second mode in response to the sensor detecting the first relative position relationship of the wearable electronic device and the first part of the user has changed to a second relative position relationship.

11. The apparatus of claim 10, wherein the controller
maintains the wearable electronic device in a first operating state based on obtained authentication data while the wearable electronic device is in the first mode; and
configures the wearable electronic device to a second operating state after the wearable electronic device is configured to the second mode if no operation is detected during a first preset period of time.

12. The apparatus of claim 11, wherein
an operable authority level of the wearable electronic device in the second operating state is lower than that of the wearable electronic device in the first operating state.

13. The apparatus of claim 10, wherein
the sensor detects a physical characteristic of the user; and
the controller
analyzes the physical characteristic to obtain the authentication data;
authenticates the wearable electronic device according to the authentication data; and
configures the wearable electronic device to the first operating state after the first processing unit successfully authenticates the wearable electronic device according to the authentication data.

14. The apparatus of claim 11, wherein the controller
maintains the wearable electronic device in the first operating state for a first preset period of time after the wearable electronic device is switched to the second mode;
detects whether an operation is made during the first preset period of time; and
if the controller detects that no operation is made during the first present period of time, the controller then configures the wearable electronic device to the second operating state.

15. The apparatus of claim 14, wherein the controller
obtains the authentication data while the wearable electronic device is in the second operating state;
authenticates the wearable electronic device according to the authentication data; and
configures the wearable electronic device to the first operating state after successfully authenticates the wearable electronic device according to the authentication data.

16. The apparatus of claim 10, wherein the controller
turns off a screen of the wearable electronic device if no operation is detected within a second preset period of time while the wearable electronic device is in the first mode and the screen is in a lit mode; and
turns on the screen of the wearable electronic device if an operation is detection while the wearable electronic device is in the first mode and the screen is in an unlit mode.
